(19) United States
(12) Patent Application Publication
(10) Pub. No.: US 2014/0249673 A1
(43) Pub. Date: Sep. 4, 2014

(54) ROBOT FOR GENERATING BODY MOTION CORRESPONDING TO SOUND SIGNAL

(71) Applicant: COMPAL COMMUNICATION, INC., Taipei (TW)

(72) Inventor: Shu-Yi Lin, Taipei (TW)

(73) Assignee: Compal Communication, Inc., Taipei (TW)

(21) Appl. No.: 13/853,472

(22) Filed: Mar. 29, 2013

(30) Foreign Application Priority Data
Mar. 1, 2013 (TW) 102107340

(51) Int. Cl. B25J 9/16

(52) U.S. Cl. CPC B25J 9/163
USPC 700/246

(57) ABSTRACT

A robot includes a storage unit, a receiving unit, a central control unit, and an implementation unit. The storage unit is used for storing a body motion script database. The receiving unit is used for receiving a sound signal. The central control unit is used for outputting a motion arrangement description file according to the messages of the sound signal, reading a corresponding body motion script from the body motion script database according to the motion arrangement description file, and generating a motion arrangement command according to the body motion script. The implementation unit includes a control circuit and a driving device. The control circuit is used for generating a control signal in response to the motion arrangement command. According to the control signal, the driving device is controlled to drive at least one moving part of the robot to generate a corresponding body motion according to the sound signal.

### FIELD OF THE INVENTION

The present invention relates to a robot, and more particularly to a robot for generating a body motion corresponding to a sound signal.

### BACKGROUND OF THE INVENTION

Recently, with improvement of living standards and increasing development of robot technologies, people's interests in high-tech entertainment apparatuses become increasingly strong. Consequently, the entertainment robot technology is developed very quickly, and a lot of entertainment robots have walked into our lives.

In the general living environment, a variety of sounds are unique. By interpreting the implicit messages contained in the sound, the meaning representing the sound can be understood by people. For example, after the sounds made by the human beings are analyzed, the basic messages implicitly contained in the sounds may be classified into sound intensity, rhythm, melody, and so on. Most people can recognize music messages, lecture messages, story-telling messages or other type messages. For example, when a symphony is heard by the average persons, the average persons can only recognize the symphony as a good music. However, when a section of the symphony is heard by the music experts, the music experts can immediately tell the composer of the music and the musical instruments used to play the symphony, even hear the symphony orchestra playing the symphony or the playing version of the symphony, and evaluate the artistic quality.

Generally, the ability to analyze, interpret and respond to various messages of the external environment indicates the intelligent level of the robot. In accordance with the operation mode of the current robot, after the sound from the external environment is received by a microphone, the received sound is further analyzed. According to the analyzing result, the conventional robot may respond to the sound in the following ways.

Firstly, if the received sound is determined as a voice command according to the analyzing result, the meaning representing the voice command is further recognized, and the robot is controlled to perform an appointed action. For example, when the robot hears a voice command “Advance”, the robot walks forwardly. When the robot hears a voice command “Go back”, the robot walks backwardly. Alternatively, if the sound is determined as a voice command “dance”, the robot dances to the specified song.

Secondly, if the received sound is associated with the sound intensity according to the analyzing result, the robot is controlled to make an action with the sound intensity. For example, when the robot hears a louder sound, the robot waves hands at a larger extent. Moreover, when the robot hears a lower sound, the robot waves hands at a smaller extent.

Thirdly, if the received sound is associated with the rhythm of the sound according to the analyzing result, the robot is controlled to move rhythmically with the rhythm.

However, the conventional robot still has some drawbacks. For example, since the response action scripts corresponding to different sounds are previously set and stored in a storage unit and these response action scripts are independently stored, the response actions corresponding to the specified sound signals are determined when the robot is fabricated. In other words, a single feature of the received sound is analyzed by the conventional robot, and thus the conventional robot is capable of analyzing and recognizing one or some specified types of sounds. In addition, since the response action scripts corresponding to different sounds are previously set and stored in a storage unit, the robot can't immediately and autonomously perform a meaningful response action for example body motion or dance with the rhythm precisely following and matching the rhythm of the sound signal. Moreover, in views of cost-effectiveness, the number of response action scripts stored in the conventional robot is limited. Consequently, the user may easily feel bored in operating the conventional robot.

Therefore, there is a need of providing an improved robot for immediately generating a body motion corresponding to a sound signal in order to eliminate the above drawbacks.

### SUMMARY OF THE INVENTION

The present invention provides a robot for immediately generating a body motion corresponding to a sound signal in order to eliminate the drawbacks encountered from the prior art. A single feature of the received sound is analyzed by the conventional robot, and thus the conventional robot is capable of analyzing and recognizing one or some specified types of sounds. In addition, since the response action scripts corresponding to different sounds are previously set and stored in a storage unit, the conventional robot can't immediately and autonomously perform a meaningful response action for example body motion or dance with the rhythm precisely following and matching the rhythm of the sound signal. Moreover, in views of cost-effectiveness, the number of response action scripts stored in the conventional robot is limited. The user may easily feel bored in operating the conventional robot. The robot of the present invention can fix the drawbacks encountered from the prior art.

In accordance with an aspect of the present invention, there is provided a robot. The robot includes a storage unit, a receiving unit, a central control unit, and an implementation unit. The storage unit is used for storing a body motion script database. The receiving unit is used for receiving a sound signal. The central control unit is electrically connected with the storage unit and the receiving unit, and includes a signal analyzing circuit and a command generating circuit. The signal analyzing circuit is used for analyzing the sound signal, thereby acquiring at least one message of the sound signal and outputting a motion arrangement description file according to the at least one message. The command generating circuit is used for reading a corresponding body motion script from the body motion script database according to the motion arrangement description file, and generating a motion arrangement command according to the body motion script. The implementation unit includes a control circuit and a driving device. The control circuit is electrically connected with the command generating circuit and the driving device for generating a control signal in response to the motion arrangement command. According to the control signal, the driving device is controlled to drive at least one moving part of the robot to generate a corresponding body motion according to the sound signal.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of a robot according to an embodiment of the present invention;

FIG. 2 is a schematic diagram showing that the robot receives a sound signal through an electronic device; and

FIG. 3 is a diagram showing the relationships between the sound signals and the response body motions performed by the robot of FIG. 2.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

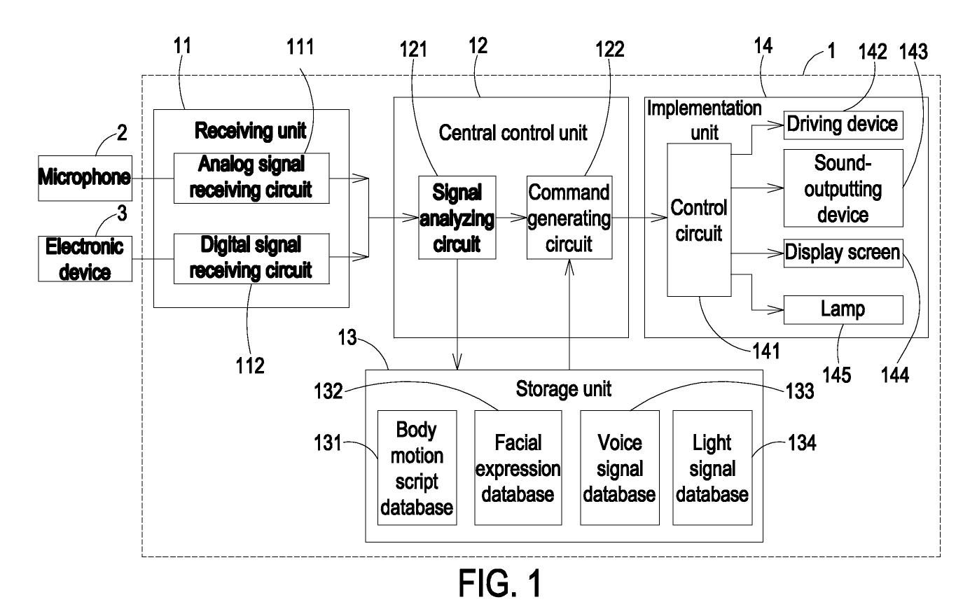

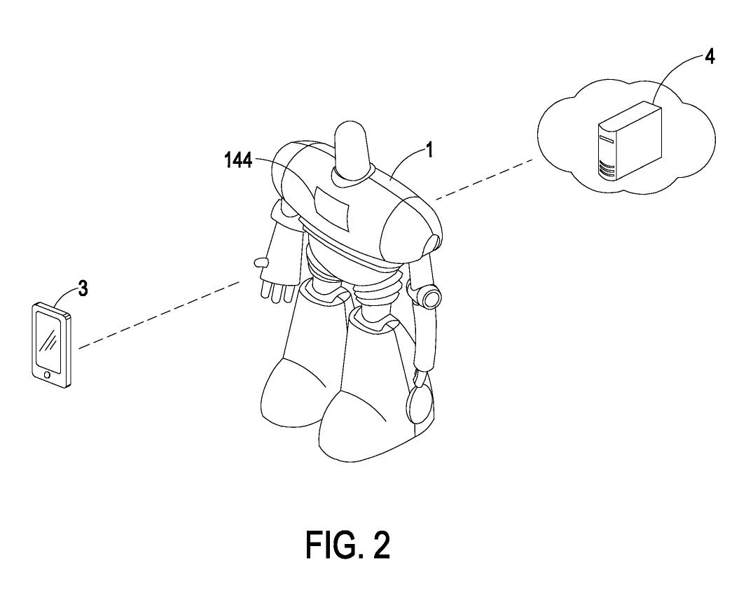

FIG. 1 is a schematic functional block diagram illustrating the architecture of a robot according to an embodiment of the present invention; and FIG. 2 is a schematic diagram showing that the robot receives a sound signal through an electronic device. As shown in FIGS. 1 and 2, the robot 1 may receive a sound signal through a microphone 1 or an electronic device 3. After the sound signal is received, the robot 1 can immediately and autonomously generate a meaningful body motion or voice response according to the sound signal. The sound signal is an analog sound signal or a digital sound signal.

As shown in FIGS. 1 and 2, the robot 1 comprises a receiving unit 11, a central control unit 12, a storage unit 13, and an implementation unit 14. Moreover, the storage unit 13 includes a body motion script database 131, a facial expression database 132, a voice signal database 133 and a light signal database 134. The body motion script database 131 includes plural scripts for generating body motions of at least one moving part of the robot 1. The moving part includes but is not limited to the head, the hands, the arms, the waist or the legs of the robot 1. The body motion to be generated according to body motion script includes but is not limited to a clapping motion, a hand-waving motion, a tango dance motion or a body language motion with happiness. The facial expression database 132 includes the facial expression data of at least one moving part of the robot 1 (e.g. the mouth or the eyes of the robot 1). The voice signal database 133 comprises plural voice signals such as voice commands, keywords and statements. The light signal database 134 comprises plural light signals such as happy light signals and sad light signals.

The receiving unit 11 comprises an analog signal receiving circuit 111 and a digital signal receiving circuit 112. One of the analog signal receiving circuit 111 and the digital signal receiving circuit 112 is used to receive the sound signal. The analog signal receiving circuit 111 is connected with or in communication with the microphone 2. The digital signal receiving circuit 112 is connected with or in communication with the electronic device 3 in a wired transmission manner or a wireless transmission manner. In a case where the sound signal to be received by the robot 1 is the analog sound signal (e.g. the external environment sound), the analog sound signal is received by the analog signal receiving circuit 111 through the microphone 2. In a case where the digital signal receiving circuit 112 is connected with or in communication with the electronic device 3, the digital sound signal from the electronic device 3 is received by the digital signal receiving circuit 112. The digital sound signal from the electronic device 3 includes but is not limited to a digital file (e.g. a MP3 file, a WAV file or a WMV file) or a sound-containing video file (e.g. a AVI file or a MP4 file). The electronic device 3 includes but is not limited to a memory card, a cloud drive or a portable electronic device (e.g. a mobile phone).

The implementation unit 14 is electrically connected with the central control unit 12. The operations of the implementation unit 14 are controlled by the central control unit 12. In this embodiment, the implementation unit 14 comprises a control circuit 141, a driving device 142, a sound-outputting device 143, a display screen 144, and a lamp 145. The control circuit 141 is electrically connected with the driving device 142, the sound-outputting device 143, the display screen 144 and the lamp 145 in order to control the operations of the driving device 142, the sound-outputting device 143, the display screen 144 and the lamp 145. An example of the driving device 142 includes but is not limited to a motor. An example of the sound-outputting device 143 includes but is not limited to a speaker.

Please refer to FIG. 1 again. The central control unit 12 comprises a signal analyzing circuit 121 and a command generating circuit 122. The signal analyzing circuit 121 is electrically connected with the analog signal receiving circuit 111, the digital signal receiving circuit 112, the storage unit 13 and the command generating circuit 122. The signal analyzing circuit 121 is used for analyzing the sound signal that is provided by the analog signal receiving circuit 111 or the digital signal receiving circuit 112, thereby acquiring at least one message of the sound signal. Moreover, the signal analyzing circuit 121 may output a motion arrangement description file according to the at least one message. The command generating circuit 122 reads a corresponding body motion script from the body motion script database 131 according to the motion arrangement description file, and generates a motion arrangement command according to the body motion script. Moreover, after the sound signal is received by the receiving unit 11 and transmitted to the implementation unit 14 through the central control unit 12, the sound signal may be outputted from the sound-outputting device 143 of the implementation unit 14.

After an analog sound signal from the analog signal receiving circuit 111 is received by the signal analyzing circuit 121, the signal analyzing circuit 121 may analyze the analog sound signal, thereby acquiring at least one message of the analog sound signal. The at least one message of the analog sound signal includes the sound intensity, the rhythm, the melody, the tone or a combination thereof. For example, by analyzing the amplitude of the analog sound signal, the message about the sound intensity is acquired. Moreover, by analyzing the rhythm, the melody and the tone of the analog sound signal, the messages about the rhythm, the melody and the tone are acquired. Therefore, the robot 1 is controlled to make an action at an extent associated with the sound intensity, and the robot 1 is controlled to move rhythmically with the acquired rhythm. Moreover, by performing a voice recognition on the analog sound signal, the voice commands, keywords and statements contained in the analog sound signal can be recognized. Moreover, by performing an emotional recognition on the analog sound signal, the moods or motions contained in the analog sound signal can be recognized.

On the other hand, after a digital sound signal is transmitted from the digital signal receiving circuit 112 to the signal analyzing circuit 121, if the digital sound signal is a digital file containing metadata (e.g. a MP3 file, a WAV file or a WMV file), the signal analyzing circuit 121 may analyze the digital file. Consequently, the acquired at least one message of the digital sound signal includes sound intensity, the rhythm, the metadata or a combination thereof. The metadata includes but is not limited to the song name, the album name, the singer name, the music type or the issue year of the digital sound signal. The signal analyzing circuit 121 can quickly judge the extent of the response action or body motion of the robot 1 according to the acquired sound intensity message, judge the speed of the response action or body motion of the robot 1 according to the acquired rhythm message, and output a motion arrangement description file according to the acquired metadata message.

Please refer to FIG. 1 again. After the motion arrangement description file based on the received sound signal is outputted by the signal analyzing circuit 121, the command generating circuit 122 reads a corresponding body motion script from the body motion script database 131 according to the motion arrangement description file, and generates a motion arrangement command according to the body motion script. In response to the motion arrangement command, the control circuit 141 of the implementation unit 14 generates a control signal in order to control the driving device 142 to drive the operations of at least one moving part (e.g. the head, the hands, the arms, the waist or the legs) of the robot 1. Consequently, the robot 1 generates a body motion corresponding to the sound signal according to the body motion script.

Moreover, the command generating circuit 122 may read a corresponding facial expression from the facial expression database 132 according to the motion arrangement description file of the sound signal, and generates a facial expression command according to the facial expression. In response to the facial expression command, the control circuit 141 of the implementation unit 14 generates a control signal in order to control the driving device 142 to drive the operations of at least one moving part (e.g. the mouth or the eyes) of the robot 1. Consequently, the robot 1 generates a corresponding facial expression.

Moreover, the command generating circuit 122 may read a corresponding light signal from the light signal database 134 according to the motion arrangement description file of the sound signal, and generates a light command according to the light signal. In response to the light command, the control circuit 141 of the implementation unit 14 generates a control signal in order to control the lamp 145 to emit a corresponding light signal such as the happy light signal or the sad light signal. Consequently, when the sound signal is outputted from the sound-outputting device 143 of the robot 1, the body motion, the facial expression and the emitted light signal can be in harmony with the sound signal. In a case where the sound signal received by the receiving unit 11 is a cheerful song, after the sound signal is analyzed and judged by the signal analyzing circuit 121, the robot 1 will generate a joyful body motion and emit a happy light signal.

Moreover, the command generating circuit 122 may read a corresponding voice signal from the voice signal database 133 according to the motion arrangement description file of the sound signal, and generates a voice command according to the voice signal. In response to the voice command, the control circuit 141 of the implementation unit 14 generates a control signal in order to control the sound-outputting device 143 to output a corresponding voice signal. For example, in a case whether the type of the sound signal is an interactive quiz between the robot 1 and the user, the command generating circuit 122 may read a corresponding voice signal from the voice signal database 133. Consequently, a voice signal for replying the sound signal is outputted from the sound-outputting device 143 of the robot 1.

After the received sound signal is analyzed by the signal analyzing circuit 121, the acquired message of the sound signal may include the time spots of generating the peaks, which are larger than a preset peak threshold value, in each time period of the sound signal according to the preset peak threshold value. According to the message, the signal analyzing circuit 121 can output a motion arrangement description file according to the message with greater precision. The command generating circuit 122 can read a corresponding body motion script from the body motion script database 131 according to the motion arrangement description file, and generates a motion arrangement command according to the body motion script. Consequently, the robot 1 is controlled to generate the body motion rhythmically with the rhythm of the sound signal.

Moreover, by executing an application software (APP) of the electronic device 3, an additional information (e.g. marketing information or promoting information) may be transmitted to the digital signal receiving circuit 112 along with the digital sound signal. Consequently, during the digital sound signal is outputted from the robot 1, the additional information is also shown on the display screen 144.

In some other embodiments, by executing an application software (APP) of the electronic device 3, a personalized setting information (e.g. “Favorite” or “Song to be listened at happy time”) may be transmitted to the digital signal receiving circuit 112 along with the digital sound signal. Consequently, according to the digital sound signal and the personalized setting information, the robot 1 generates a corresponding body motion. For example, in a case where a digital sound signal and a personalized setting information “Song to be listened at happy time” are simultaneously received by the digital signal receiving circuit 112, the robot 1 generates a body motion corresponding to the digital sound signal and generates a happy facial expression corresponding to the personalized setting information.

Moreover, the robot 1 of the present invention has a function of updating the data of the storage unit 13. For achieving this function, the robot 1 is equipped with a wireless transmission module (not shown). When the wireless transmission module is in communication with a cloud drive 4 of a remote service providing platform, the data stored in the cloud drive 4 may be automatically downloaded to the storage unit 13. Consequently, the robot 1 can generate more meaningful body motions corresponding to different sound signals, and the robot 1 is more humanized.

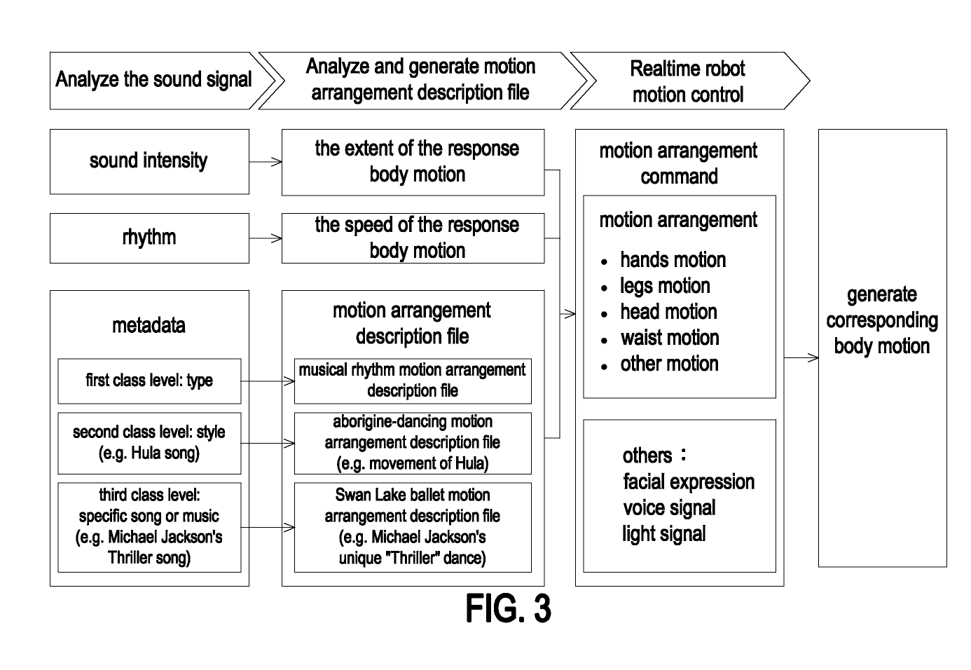

FIG. 3 is a diagram showing the relationships between the sound signals and the response body motions performed by the robot of FIG. 2. Please refer to FIG. 3 and FIG. 2. When a sound signal transmitted from the receiving circuit 11 is received by the central control unit 12, the signal analyzing circuit 121 of the central control unit 12 can analyze the sound signal and acquire three messages of the sound signal in real time. The three messages of the sound signal include the sound intensity, the rhythm and the metadata of the sound signal. The signal analyzing circuit 121 can quickly judge the extent of the response action or body motion of the robot 1 according to the acquired sound intensity message, judge the speed of the response action or body motion of the robot 1 according to the acquired rhythm message, and output a motion arrangement description file according to the acquired metadata message. In an embodiment, the metadata message of the sound signal may include three class levels. The first class level is the widest class of the sound signal. The first class level is used for analyzing and acquiring the type of the sound signal for example the type of lecture, story-telling, music, singing-song or symphony. The second class level is the subclass of the sound signal. The second class level is used for analyzing and acquiring the style (i.e. genre) of the music for example the style of ballad, jazz, rock or classics. The third class level is the most detailed class of the sound signal. The third class level is used for analyzing and acquiring the song name, the singer name or the version of a specific song or music.

Accordingly, the signal analyzing circuit 121 can output a motion arrangement description file according to the acquired messages.

The motion arrangement description files generated and outputted by the signal analyzing circuit 121 according to the acquired metadata messages will be illustrated with examples as below.
1. First class level—the type of the sound signal. When the type of the sound signal analyzed and acquired by the signal analyzing circuit 121 is the music type, the motion arrangement description file outputted by the signal analyzing circuit 121 is a musical rhythm motion arrangement description file containing musical rhythm motion descriptions. When the type of the sound signal analyzed and acquired by the signal analyzing circuit 121 is the story-telling type, the motion arrangement description file outputted by the signal analyzing circuit 121 is a gesture movement arrangement description file containing body movement descriptions when performing a presentation.
2. Second class level—the style (i.e. genre) of the music. When the type of the sound signal analyzed and acquired by the signal analyzing circuit 121 is the music type and the style of the music analyzed and acquired by the signal analyzing circuit 121 is the Hawaii hula-dancing music, the motion arrangement description file outputted by the signal analyzing circuit 121 is a hula-dancing motion arrangement description file containing hula-dancing characteristic motion descriptions. When the type of the sound signal analyzed and acquired by the signal analyzing circuit 121 is the music type and the style of the music analyzed and acquired by the signal analyzing circuit 121 is the aboriginal music, the motion arrangement description file outputted by the signal analyzing circuit 121 is an aborigine-dancing motion arrangement description file containing aborigine-dancing characteristic motion descriptions.

Certainly, the styles of the music capable of being analyzed and acquired by the signal analyzing circuit 121 are not limited to the Hawaii hula-dancing music and the aboriginal music as described above, other styles of distinctive music can also be analyzed and acquired by the signal analyzing circuit 121, so that the motion arrangement description file outputted by the signal analyzing circuit 121 is a motion arrangement description file containing distinctive and characteristic motion descriptions.
3. Third class level—some specific songs or music. When the third class level of the sound signal analyzed and acquired by the signal analyzing circuit 121 is a specific music such as Swan Lake ballet, the motion arrangement description file outputted by the signal analyzing circuit 121 is a Swan Lake ballet motion arrangement description file containing Swan Lake ballet characteristic motion descriptions. When the third class level of the sound signal analyzed and acquired by the signal analyzing circuit 121 is a specific song such as a specific song of Michael Jackson (for example Michael Jackson's song entitled “Thriller”), the motion arrangement description file outputted by the signal analyzing circuit 121 is a Michael Jackson motion arrangement description file containing Michael Jackson characteristic motion descriptions.

After the three messages of the sound signal are analyzed and acquired by the signal analyzing circuit 121 in real time, the command generating circuit 122 reads a corresponding body motion script from the storage unit 13 according to the motion arrangement description file and generates a motion arrangement command according to the body motion script, so that the implementation unit 14 is controlled to drive at least one moving part of the robot 1 to generate a corresponding body motion in response to the motion arrangement command. In addition, the extent of the response body motion of the robot 1 can be adjusted and controlled according to the acquired sound intensity message, and the speed of the response body motion of the robot 1 can be adjusted and controlled according to the acquired rhythm message. Consequently, according to the sound signal, the robot 1 can generate a suitable and meaningful body motion in real time.

From the above discussions, the signal analyzing circuit 121 of the robot 1 can acquire at least one message of the received sound signal and output corresponding motion arrangement description file to create different levels of response action according to the amount of the acquired messages. For example, if the at least one message analyzed by the robot 1 only contains the sound intensity of the sound, the response of the robot includes the intensity of the body motion or the intensity of the output sound. Moreover, if the at least one message analyzed by the robot 1 contains the rhythm of the sound signal, the robot 1 is moved and performs a body motion rhythmically with the fast rhythm or the slow rhythm of the sound signal. Moreover, if the at least one message analyzed by the robot 1 contains the type, the style (i.e. genre) or the song name of the sound signal (e.g. a story-telling type, a tango dance music or a waltz dance music), the body motion generated by the robot 1 is more delicate and more meaningful. For example, when the sound signal contains the story-telling type message, the robot 1 generates the body motion harmony with the sound signal. When the robot 1 hears the tango dance music, the robot 1 may dance tango and recognize the name of the music, or even make the signature move or dance step of the original singer. In other words, after the sound signal is received, the robot 1 can immediately and autonomously generate a meaningful body motion, a facial expression, a light signal and/or a voice signal according to the sound signal.

From the above descriptions, the present invention provides a robot for immediately generating a body motion corresponding to a sound signal. After the received signal is analyzed by the signal analyzing circuit, at least one message of the sound signal is acquired and the motion arrangement description file is outputted according to the at least one message. Consequently, the command generating circuit reads a corresponding body motion script from the body motion script database according to the motion arrangement description file, and generates a motion arrangement command according to the body motion script. In response to the motion arrangement command, the driving device is controlled to drive at least one moving part of the robot to generate a corresponding body motion according to the body motion script. Consequently, according to the sound signal, the robot can immediately and autonomously generate a meaningful body motion. When the robot of the present invention is operated by the user, the user may feel that the robot is interesting and fresh or even has a life.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A robot, comprising:
a storage unit for storing a body motion script database;
a receiving unit for receiving a sound signal;
a central control unit electrically connected with said storage unit and said receiving unit, and comprising:
a signal analyzing circuit for analyzing said sound signal, thereby acquiring at least one message of said sound signal and outputting a motion arrangement description file according to said at least one message; and
a command generating circuit for reading a corresponding body motion script from said body motion script database according to said motion arrangement description file, and generating a motion arrangement command according to said body motion script; and
an implementation unit comprising a control circuit and a driving device, wherein said control circuit is electrically connected with said command generating circuit and said driving device for generating a control signal in response to said motion arrangement command, wherein according to said control signal, said driving device is controlled to drive at least one moving part of said robot to generate a corresponding body motion according to said sound signal.

2. The robot according to claim 1, wherein said sound signal is an analog sound signal, and said receiving unit comprises an analog signal receiving circuit for receiving said analog sound signal through a microphone.

3. The robot according to claim 2, wherein said at least one message of the analog sound signal includes a sound intensity, a rhythm, a melody, a tone or a combination thereof.

4. The robot according to claim 1, wherein said sound signal is a digital sound signal, and said receiving unit comprises a digital signal receiving circuit for receiving said digital sound signal from an electronic device in a wired transmission manner or a wireless transmission manner.

5. The robot according to claim 4, wherein said at least one message of said digital sound signal includes a sound intensity, a rhythm, a metadata or a combination thereof, wherein said metadata includes a song name, an album name, a singer name, a music type or an issue year.

6. The robot according to claim 4, wherein said implementation unit further comprises a display screen, wherein when said digital sound signal is received by said receiving unit, an additional information is also received by said received unit, so that said additional information is shown on said display screen.

7. The robot according to claim 4, wherein when said digital sound signal is received by said receiving unit, a personalized setting information is also received by said received unit, so that said robot is controlled to generate said corresponding body motion according to said sound signal and said personalized setting information.

8. The robot according to claim 1, wherein a facial expression database is further stored in said storage unit, wherein said command generating circuit reads a corresponding facial expression from said facial expression database according to said motion arrangement description file, and generates a facial expression command according to said facial expression, wherein in response to said facial expression command, said control circuit generates an additional control signal, wherein according to said additional control signal, said driving device is controlled to drive said at least one moving part of said robot to generate said facial expression.

9. The robot according to claim 1, wherein a voice signal database is further stored in said storage unit, and said implementation unit further comprises a sound-outputting device, wherein said command generating circuit reads a corresponding voice signal from said voice signal database according to said motion arrangement description file, and generates a voice command according to said voice signal, wherein in response to said voice command, said control circuit generates an additional control signal, wherein according to said additional control signal, said sound-outputting device is controlled to output said voice signal.

10. The robot according to claim 1, wherein a light signal database is further stored in said storage unit, and said implementation unit further comprises a lamp, wherein said command generating circuit reads a corresponding light signal from said light signal database according to said motion arrangement description file, and generates a light command according to said light signal, wherein in response to said light command, said control circuit generates an additional control signal, wherein according to said additional control signal, said lamp is controlled to output said light signal.

11. The robot according to claim 1, wherein said sound signal is analyzed by said signal analyzing circuit, and said at least one message of said sound signal includes the time spots of generating a plurality of peaks, which are larger than a preset peak threshold value, in each time period of said sound signal according to said preset peak threshold value, wherein said signal analyzing circuit outputs said motion arrangement description file according to said at least one message of said sound signal, and wherein said command generating circuit read said corresponding body motion script from said body motion script database according to said motion arrangement description file, so that said robot is controlled to generate said body motion rhythmically with the rhythm of said sound signal.
